(19) United States
(12) Patent Application Publication
(10) Pub. No.: US 2025/0341091 A1
(43) Pub. Date: Nov. 6, 2025

(54) Vibration Absorber Arrangement

(71) Applicant: WÖLFEL ENGINEERING GMBH + CO. KG, Höchberg (DE)

(72) Inventors: -Ing. Sebastian KATZ, Würzburg (DE); -Ing. Jürgen ENGELHARDT, Eisingen (DE)

(73) Assignee: WÖLFEL ENGINEERING GMBH + CO. KG, Höchberg (DE)

(21) Appl. No.: 18/871,251

(22) PCT Filed: Jun. 6, 2023
(86) PCT No.: PCT/EP2023/065085

§ 371 Date: Dec. 3, 2024

(30) Foreign Application Priority Data
Jun. 9, 2022 (EP) 22178024.0

(51) Int. Cl. E04B 1/98; F16F 13/04

(52) U.S. Cl. CPC E04B 1/98; F16F 13/04

(57) ABSTRACT

A vibration absorber arrangement (1) is provided, in particular for tall slender structures, comprising a supporting structure (8), an absorber mass (2) which comprises a center of mass (3), and at least one wheel (4, 5) by means of which the absorber mass (2) is movable on a concavely curved rail arrangement (6), which is connected to the supporting structure (8), from a stable central position in two opposite directions, wherein a friction damper device (9) is provided. One wants to be able to adapt such a vibration absorber arrangement in a simple manner to different operating requirements. For this, it is provided that the friction damper device (9) is adjustable between a first state, in which it does not interact with the absorber mass (2) or only dampeningly, and a second state, in which it controlledly brings a movement of the absorber mass (2) to a standstill.

### BACKGROUND

The present invention relates to a vibration absorber arrangement, in particular for tall slender structures, having a supporting structure, an absorber mass which comprises a center of mass, and at least one wheel by means of which the absorber mass is movable on a concavely curved rail arrangement, which is connected to the supporting structure, from a stable central position in two opposite directions, wherein a friction damper device is provided.

A vibration absorber arrangement is known from CN 109 707 777 A.

Another vibration absorber arrangement is known, for example, from EP 2 746 483 B1.

The invention is described below by reference to the application in the tower of a wind energy plant. However, it is also applicable to other tall and slender structures, such as chimneys, antennas, skyscrapers, towers, or offshore structures, such as transformer stations. As a “tall and slender structure” shall be understood a structure that has a ratio between height and smallest width of at least five.

The tower of a wind energy plant is excited to vibrate, for example by wind forces or—in the case of offshore plants-also by wave forces. Thereby, the tower oscillates at a relatively low frequency of less than 1 Hz. As a rule, the tower of an offshore wind energy plant exhibits a frequency in the range of 0.1 to 0.3 Hz. With each oscillation movement, the tower bends slightly, which can lead to problems in the long run.

It is therefore known to use a vibration absorber whose absorber mass can be moved on a curved rail arrangement back and forth. A line, which passes through the center of a wheel and the point of support of the wheel on the rail arrangement crosses with a corresponding line of the wheel at another position. The crossing point then forms, so to speak, the suspension for a pendulum, so that a distance between this crossing point and the center of mass, in other words the pendulum length, can be made very large.

Each vibration absorber arrangement must be very precisely matched to its intended application. Thereby, it must also be taken into account that the vibration absorber arrangement is exposed to different operating states. In addition to the “normal” use in continuous operation, the vibration absorber arrangement must be serviced occasionally. The vibration absorber arrangement must also be possible to be transported and installed.

EP 2 746 483 A1 discloses a vibration absorber arrangement with an absorber mass comprising a center of mass and with at least one wheel, with which the absorber mass is movable on a concavely curved rail arrangement, which is connected to the supporting structure, from a stable central position in two opposite directions.

US 4 807 840 A shows a vibration absorber arrangement with a supporting structure, an absorber mass comprising center of mass, and with at least one wheel with which the absorber mass is moveable on a rail arrangement in two opposite directions. Furthermore, a friction damper device is provided.

US 6 019 056 A shows a damping device for a ship, which is intended to dampen its rolling motion. The dampening device has a mass which is movable by wheels on a curved track from a stable central position in two opposite directions. A magnetic damper is provided.

US 2018/0252287 A1 discloses another vibration damper with a rotating mass, wherein the rotating mass is attached to a holder, which is movable on a concave curved rail.

The invention underlies the problem to be able to adapt a vibration absorber arrangement to different operating requirements in a simple manner.

This problem is solved in a vibration absorber arrangement of the type mentioned at the beginning in that an adjustable friction damper device is provided, which is adjustable between a first state, in which it does not interact with the absorber mass or only interacts dampeningly, and a second state, in which it controlledly brings a movement of the absorber mass to a standstill.

With such a friction damper device, it is on the one hand possible to increase the absorber damping if this is necessary. On the other hand, the friction damper device can also be used to slow down the absorber mass to such an extent that, even with excitations of the supporting structure from the outside, it comes to a standstill, if this is necessary for maintenance purposes. Thereby, hard braking or blocking of the absorber mass, which in turn would lead to an undesired large load on the supporting structure, is avoided. If one puts the friction damper device out of engagement with the absorber mass, the friction damper device does not affect the absorber damping. However, by adjustment of the friction damper device, the damping of the vibration absorber arrangement can be adapted to different operating states of the supporting structure, e.g., different tower frequencies.

Preferably, the friction damper device comprises a bias spring arrangement, which is arranged between an adjustment device and at least one friction lining element. The adjustment device thus acts on the friction lining element or friction lining elements via the bias spring arrangement. Thereby, the bias spring arrangement is relatively soft. By “soft” bias spring arrangement, it is meant that the bias spring arrangement must be strongly biased to achieve a high force or, conversely, experiences little change in force when it undergoes small changes in travel compared to a preload travel, for example when the friction lining wears. This ensures that the set friction damping reacts robustly, i.e., with little sensitivity, to changes in the preload travel, which is favorable for the absorber effectiveness.

Preferably, the friction lining element comprises a useful thickness and the bias spring arrangement has a spring constant, at which the spring force of the bias spring arrangement changes between a first spring length and a second spring length, which is a sum of the first spring length and the useful thickness, by less than 10%. The friction lining element rubs against the absorber mass when the absorber mass moves and is thereby worn and abraded. The bias spring arrangement compensates for the wear of the friction lining element without inadmissibly changing the damping effect of the vibration damper arrangement. The usable thickness may be, for example, a thickness intended for wear of the friction lining of the friction lining element. Higher frequencies of the supporting structure require more damping. This is taken into account by the adjustability of the damping effect.

The friction lining element may include, for example, materials such as used in other brake lining applications.

In one embodiment, the friction damper device is in the first state when the adjustment device is in a first position so that the friction damper device does not interact with the absorber mass or only dampeningly via the at least one friction lining element. Alternatively or additionally, the friction damper device is in the second state when, in a second position of the adjustment device, the friction lining element is pressed against the absorber mass such that the movement of the absorber mass is brought controlledly to a standstill.

Preferably, the adjustment device overpresses the bias spring arrangement in the second position. Here, overpressed means that the bias spring arrangement is pressed significantly harder than is required for damping setting of the absorber. The function here is then merely to brake the absorber, no longer a damping setting. The bias spring arrangement is then fully compressed, i.e. in a state in which it cannot be elastically compressed any further. In principle, this pressing on does not have to be done exclusively via the spring. In the second position, the bias spring arrangement is compressed to such an extent that the force of the adjustment device is transmitted directly to the friction lining element. When using a helical compression spring is as bias spring arrangement, the helical compression spring is fully compressed in the second position. For example, in this state, it is no longer elastically compressible. If other springs are used as bias spring arrangement, a full compression, which does no longer permit a further compression, cannot usually be achieved. Nevertheless, even in this case the adjustment device can act practically directly on the absorber mass.

It is also preferred that the bias spring arrangement has a first spring and a second spring, which are arranged in series and have different stiffnesses. The softer spring is used for the selective adjustment of the damping. The harder spring, which is for example at least 5 times stiffer than the soft spring, is used for controlled braking of the absorber mass when the absorber mass is to be brought to a standstill. In this case, the soft spring is compressed first. After utilization of the available suspension travel of the soft spring, the stiffer spring is compressed. Due to the arrangement of the additional stiffer spring, a defined braking force is created and a blocking between the absorber mass and the brake is prevented.

In a preferred embodiment, it is provided that the at least one friction lining element interacts with a friction surface aligned in the direction of gravity. The friction lining element thus acts on the friction surface in horizontal direction. Thereby, it is prevented that a force acting in the direction of gravity on the absorber mass influences the vibration behavior of the absorber mass in an undesirable manner. The absorber frequency is therefore not influenced by an additional “weight force”. Thereby, the friction surface does not have to be aligned exactly in the direction gravity. Smaller deviations of the friction surface from the direction of the gravity are acceptable as long as a force exerted by the friction lining element on the friction surface in the direction gravity does not have an undesired effect on the vibration behavior of the absorber mass.

In a preferred embodiment it is provided, that the absorber mass has a groove, and the friction surface forms a side wall of the groove. The friction lining element is then arranged in the groove. Preferably, two friction lining elements are provided here, which act on opposite side walls of the groove. When the friction damper device acts on the absorber mass, the friction lining elements are braced against the side walls of the groove.

Preferably, the adjustment device comprises an angular gear, especially a worm gear. The adjustment device can then still be operated from above in the direction of gravity, which facilitates the adjustment of the friction damper device.

Preferably, a locking device is provided with which the absorber mass can be secured relative to the supporting structure, in particular in several different positions. When the friction damper device has brought the absorber mass to a standstill, the locking device is additionally used to prevent movement of the absorber mass. The locking device can exert a greater holding force on the absorber mass than the friction damper device. An endangerment of the maintenance personnel is thereby avoided.

Preferably, an inclination adjustment device is provided with which an inclination of the vibration absorber arrangement relative to the supporting structure is changeable. Due to this tilt compensation the vibration absorber arrangement can operate as intended even if the structure, for example the tower of a wind energy plant, is not exactly vertically aligned. An exact vertical alignment can only be achieved with great difficulty in many cases. However, due to the changeable inclination of the vibration absorber arrangement this is no longer a problem.

Preferably, the vibration absorber arrangement comprises an enclosure which is connected to the supporting structure, wherein the tilt adjustment device acts in particular on the enclosure. The enclosure ensures that the vibration absorber arrangement forms a “block”, so to say, that can be handled as a unit, which facilitates transport and assembly. In particular, the enclosure allows that the vibration absorber arrangement always maintains a predetermined orientation to gravity, thus also during transport and assembly. The risk that the vibration absorber arrangement is being inadvertently placed on a side or on edge is thereby greatly reduced.

Preferably, between the absorber mass and an end stop an impact buffer arrangement is provided, which comprises a force transmission device connected to the supporting structure.

The end stop may limit a maximum deflection of the absorber mass in at least one deflection direction. In one embodiment the maximum deflection in both directions is limited by an end stop each.

The impact of the absorber mass against the supporting structure is mitigated by the impact buffer arrangement with a relatively long travel. The impact buffer assembly may comprise spring elements made of steel or elastomer. In order to keep the impact forces of the absorber mass away from the enclosure, the impact forces are transmitted directly into the supporting structure by the force transmission device, i.e., in the case of a wind energy plant into the connection between the wind energy plant and the vibration absorber arrangement. It is advantageous if there are no long distances between the force application device and the supporting building.

Here, it is preferred that the impact buffer arrangement comprises an impact absorber, wherein the center of mass, the impact absorber and the force transmission device are in line when the absorber mass reaches the force application device, preferably in a straight line. In this way, one can keep the effect of the impact forces on the wheel or wheels kept small. The load on the wheel or wheels can thus be kept small.

Preferably, the impact buffer arrangement defines a braking distance that corresponds to at least 10% of the maximum deflection of the absorber mass. The movement of the absorber mass is not stopped abruptly at its end, but the absorber mass is braked over a relatively long braking distance, so that loads on the supporting structure can be kept low.

Preferably, the absorber mass is connected via an auxiliary spring device to the supporting structure, the spring force of which in particular is adjustable. Some operating states with a higher natural frequency require an increase in the absorber stiffness, which can be increased by the introduction of the auxiliary spring device. Due to the adjustability of the spring force of the auxiliary spring device, the absorber stiffness can be adjusted in a targeted manner.

Preferably, the rail arrangement has a curvature which deviates from a circular path. In case of a circular path, there is a relatively linear restoring force, i.e., a restoring force which increases proportionally to the deflection of the absorber mass. In case of a non-circular curvature, a greater restoring force towards the end of the movement space can be obtained, which in turn can be used to avoid a hard impact or to selectively obtain an amplitude-dependent frequency change.

Preferably, the vibration damper arrangement comprises an eddy current damper with a magnet arrangement and an electrical conductor arrangement, wherein the magnet arrangement and the conductor arrangement move relative to one another during a movement of the absorber mass relative to the supporting structure. The magnet arrangement can be arranged, for example, on the absorber mass, while the conductor arrangement is arranged stationary. When the magnet arrangement moves relative to the conductor arrangement, eddy currents are induced in the conductor arrangement, which in turn extract energy from the vibration movement of the absorber mass and thus contribute to the damping. It is also possible to arrange the conductor arrangement on the wheel or wheels, so that the relative movement between the conductor arrangement and the magnet arrangement results from a rotation of the wheel or wheels.

In a preferred embodiment, it is provided that the rail arrangement is a first rail arrangement, the absorber mass is a first absorber mass and a second absorber mass is moveable on a concavely curved second rail arrangement, which is connected to the supporting structure and aligned transversely to the first rail arrangement, from a stable central position in two opposite directions, wherein the first absorber mass and the first rail arrangement are arranged in a first enclosure, the second absorber mass and the second rail arrangement are arranged in a second enclosure and the first enclosure and the second enclosure are arranged one above the other in the direction of gravity. Thus, a vibration absorber arrangement with two vibration absorbers is used, which are essentially built in the same manner but are arranged with different vibration directions. By combination of the two vibration absorbers, a vibration damping can then be achieved in virtually all directions perpendicular to the direction of gravity.

Here, it is preferred that the second enclosure is arranged off-center to the first enclosure in direction of the first rail arrangement and/or the first enclosure is arranged off-center to the second enclosure in direction of the second rail arrangement. The two enclosures are then not located one above the other with their centers in the direction of gravity but are arranged laterally offset relative to one another. This is particularly advantageous when the vibration absorber arrangement is used in a wind energy plant, because here, as a rule, a cable is to be guided in the center of the tower of the wind energy plant as far as possible. The two vibration absorbers are then arranged laterally next to the cable.

### BRIEF DESCRIPTION OF THE DRAWINGS

Below, the invention is described in more detail with reference to a preferred embodiment in conjunction with a drawing. Herein show:

FIG. 1 illustrates a schematic representation of a vibration absorber arrangement without engagement with a friction damper device,

FIG. 2 illustrates a vibration absorber arrangement according to FIG. 1 with engagement of the friction damper device and with auxiliary springs,

FIG. 3 illustrates the vibration absorber arrangement with activated locking device,

FIG. 4 illustrates a schematic representation of a tower of a wind energy plant,

FIG. 5 illustrates a schematic representation of a bias spring arrangement,

FIG. 6 illustrates a side view of a modified embodiment and

FIG. 7 illustrates a front view of the embodiment according to FIG. 6.

In all figures, identical and mutually corresponding elements are provided with the same reference signs. For the sake of clarity, not all elements are shown in all figures.

### Reference Signs

1 vibration absorber arrangement
2 absorber mass
3 center of mass
4, 5 wheel
6 rail arrangement
7 enclosure
8 supporting structure
9 friction damping device
10-10b friction lining element
11 lever
12 pivot point
13 adjustment device
14 bias spring arrangement
15 locking device
16 magnet device
17 electrical conductor arrangement
18 inclination adjustment device
19 impact buffer
20 force transmission device
21 auxiliary spring device
22 cable
23 tower
24, 25 spring
26 groove
27a, 27b friction surface
28 direction change gear (angular gear)

### DETAILED DESCRIPTION OF THE INVENTION

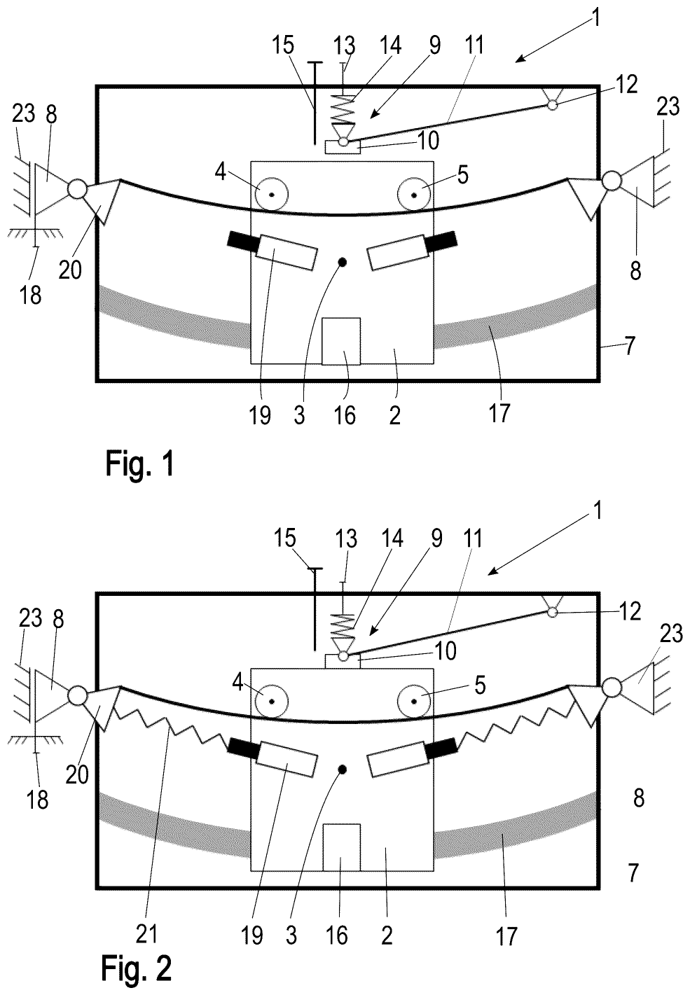

FIG. 1 schematically shows a vibration absorber arrangement 1 which can be used, for example, in a tower 23 a wind energy plant. However, the vibration absorber arrangement 1 can also be used in other high and slender structures in which a ratio of height to smallest width is at least five. In FIG. 1 tower 23 of the wind energy plant schematically shown as supporting structure.

The vibration absorption arrangement 1 has an absorber mass 2 with a center of mass 3. The absorber mass 2 may have a mass of several tons. It can be made, for example, from concrete, steel, a combination of steel and concrete or other materials.

The absorber mass 2 comprises two wheel pairs. Of each wheel pair, only the wheels 4, 5 located on the side of the absorber mass 2 shown in the drawing are visible. The wheels 4, 5 are arranged on a rail arrangement 6. The rail arrangement 6 is curved. In the present case, the curvature is circular. However, the curvature of the rail arrangement 6 may also deviate from the circular shape. In particular, the radius of curvature can decrease towards the two ends of the rail arrangement 6, so that restoring forces on the absorber mass 2 become greater when the absorber mass 2 approaches the respective end of the rail arrangement 6.

The absorber mass 2 and the rail arrangement 6 are arranged in an enclosure 7, which is connected via a supporting structure 8 in the form of a connection to the tower 23 of the wind energy plant. The rail arrangement 6 can also be connected directly to the connection.

A friction damper device 9 is provided which comprises a friction lining element 10, which is mounted on a lever 11, which is pivotable about a pivot point 12 arranged on the housing 7. This lets the friction lining element 10 be lifted off the absorber mass 2, as shown in FIG. 1, or be abut on the absorber mass 2, as shown in FIG. 2.

To adjust the position of the friction lining element 10, an adjustment device 13 is provided, which acts on the friction lining element 10 via a bias spring arrangement 14. The bias spring arrangement 14 is relatively soft. For example, in one embodiment, the preload spring arrangement 14 can be configured such that a contact force changes by less than 10% in the intended range of motion.

It is also possible to attach the friction lining element 10 to the absorber mass 2 and to connect a rail or another counterpart to the enclosure 7. In this case, the bias spring arrangement 14 acts on the rail and presses it against the friction lining element 10.

It is also possible to attach the friction lining element 10 to the absorber mass 2 and connect a rail or other counterpart to the enclosure 7. In this case, the bias spring arrangement 14 acts on the rail and presses it against the friction lining element 10.

The friction lining element 10 has a usable thickness. The usable thickness may be defined, for example, by that the friction lining element 10 comprises a friction lining, not shown in detail, which wears over time. The allowable wear defines the usable thickness. Accordingly, the bias spring arrangement 14 of the friction lining element 10 comprises a spring constant that is such that the force exerted by the bias spring arrangement 14 on the friction lining element 10 does not change, or changes only to a small permissible degree, even when the friction lining element 10 wears. The small permissible degree is at most 10%.

The adjustment device 13 can further be used to press the friction lining element 10 against the absorber mass 2 with a significantly greater force. In this case, the bias spring arrangement 14 is overpressed. This means that the spring 14 is compressed to such an extent that a movement of the adjustment device 13 is transmitted practically directly to the friction lining element 10, so that the bias spring arrangement 14 cannot be compressed any further. The friction lining element 10 can therefore additionally be used to brake the tilting mass 2 in a controlled manner, even if the tower 23 continues to be excited to vibrations. The braking can take place gradually, so that an abrupt braking of the absorber mass 2 from full speed can be avoided. Such an abrupt braking from full speed would lead to an impermissibly high load on the supporting structure.

As shown in FIG. 5, the bias spring arrangement 14 comprises a first spring 24 and a second spring 25. The two springs 24, 25 are arranged one behind the other in the operating direction or connected in series. The two springs 24, 25 comprise different stiffnesses. The spring 24 is softer or less stiff and is used for selective adjustment of the damping. The harder or stiffer spring 25 is used for controlled braking of the absorber mass 2. For example, the stiffer spring 25 is 6 times stiffer than the softer spring 24. When the absorber mass 2 is to be brought controlledly to a stillstand, the adjustment device 13 first compresses the softer spring 24. After utilization of the available spring travel of the softer spring 24, the stiffer spring 25 is compressed. Due to the stiffer spring 25 a defined braking force is generated on the damper mass 2 and it is prevented, that a blocking occurs between the damper mass 2 and the friction lining element 10.

A locking device 15 is provided, which is disengaged with the absorber mass 2 in “normal operation”. This is shown in FIGS. 1 and 2. When the absorber mass 2 has been brought to a standstill by the friction damper device 9, then the locking device 15 can be brought into engagement with the absorber mass 2 in order to reliably hold the absorber mass 2 in its stopped position. This is necessary, for example, during maintenance work. The locking device 15 can act on the absorber mass 2 with positive or frictional locking. Preferably, the locking device 15 acts on the absorber mass 2 such that it can hold the absorber mass 2 in virtually any position. The locking device 15 acts on the absorber mass 2 with a force that is greater than the force of the friction damper device 9 when braking the absorber mass 2.

On the absorber mass 2 a magnet arrangement 16 is arranged. In the enclosure 7 an electrical conductor arrangement 17 is arranged. When the absorber mass 2 during an vibrating movement moves on the rail arrangement 6, the magnet arrangement 16 is moved past the electrical conductor arrangement 17 and thereby induces eddy currents. The energy required for this is extracted from the kinetic energy of the absorber mass 2. This results in a damping. By fine-tuning the magnet arrangement 16 and/or the electrical conductor arrangement 17 the damping caused by the eddy currents can be adjusted relatively precisely.

At least on one side of the enclosure 7, i.e., at one end of the rail arrangement 6, an inclination adjustment device 18 is provided, with which the inclination of the enclosure 7 relative to the tower 23 of the wind energy plant can be adjusted. This allows, that for a symmetrical rail arrangement 6, both ends of the rail arrangement 6 can be arranged at the same height in the direction of gravity, even if the tower 23 is not aligned exactly vertically.

An impact buffer arrangement is provided, which comprises an impact buffer 19 and a force transmission device 20. In the present case, the impact buffer 19 is arranged on the absorber mass 2. However, it can also be arranged on the supporting structure 8. A corresponding impact buffer arrangement is provided on the opposite side of the absorber mass 2. The impact buffer arrangement causes that the speed of the absorber mass 2 is decreased more at the end of its movement than would be the case due to the curved rail arrangement 6 alone. This prevents hard hits of the absorber mass 2 on the supporting structure 8. The impact buffer 19 forms an impact absorber. When the absorber mass 2 reaches the force transmission device 20, the center of mass 3, the impact buffer 19 and the force transmission device 20 lie in a straight line. Thereby a load on the wheels 4, 5 is kept to low.

The impact buffer arrangement defines a braking distance which is relatively long. It is at least 10% of the maximum deflection of the absorber mass 2.

FIG. 2 shows that the absorber mass 2 is also connected to the supporting structure 8 via an auxiliary spring device 21. The auxiliary spring device 21 can engage on the impact buffer 19. On the one hand, it increases the absorber stiffness and thus the absorber frequency. On the other hand, it contributes to braking the absorber mass 2 when it reaches the end of the rail arrangement 6. In this case, forces from the auxiliary spring device 21 act on the absorber mass 2, which are caused by that the auxiliary spring device 21 is strained by tension on one side of the absorber mass 2 and by compression on the other side of the absorber mass 2.

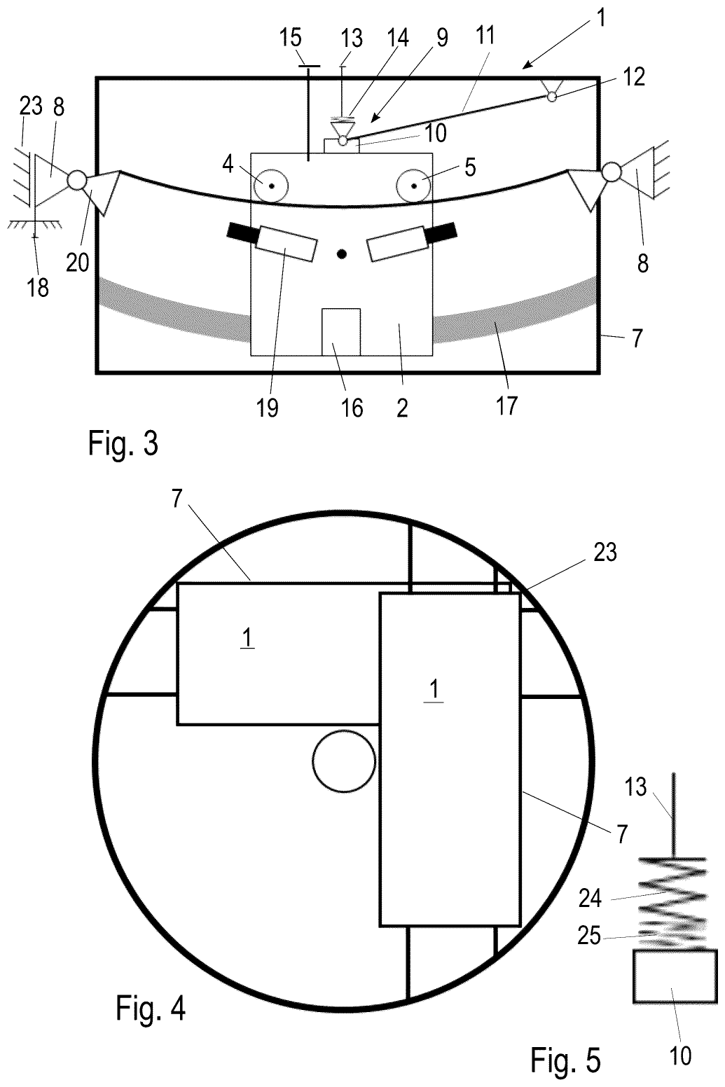

The vibration absorber arrangement 1 shown in FIGS. 1 to 3 can damp vibrations in one direction, with reference to the illustrations of FIGS. 1 to 3, a vibration from left to right and vice versa.

To be able to cover other vibration directions as well, two vibration absorber arrangements 1 are provided in the tower 23 of the wind energy plant, as shown in FIG. 4. Of the two vibration absorber arrangements 1, only the enclosures 7 are shown. The enclosures 7 of the two vibration absorber arrangements 1 are arranged one above the other in direction of gravity, which can be seen from the fact that the in direction of gravity upper vibration absorber arrangement 1 partially covers the in direction of gravity lower vibration absorber arrangement 1.

Furthermore, the two vibration absorber arrangements 1 are not arranged centrally with respect to one another. The in direction of gravity upper vibration absorber arrangement is offset to the right (with respect to the representation of FIG. 4) with respect to the center of the in direction of gravity lower vibration absorber arrangement 1, and the in direction of gravity lower vibration absorber arrangement 1 is offset upwardly (with respect to the representation of FIG. 4) with respect to the center of the in direction of gravity upper vibration absorber arrangement 1. The longitudinal direction of the two vibration absorber arrangements corresponds in each case to the orientation of the rail arrangement 6, i.e., the rail arrangement 6 runs parallel to the longer side of the enclosure 7.

This arrangement has the advantage that a cable 22, which connects a generator arranged in a nacelle of the wind energy plant with an out-conduction, can be arranged centrally in the tower 23 of the wind energy plant.

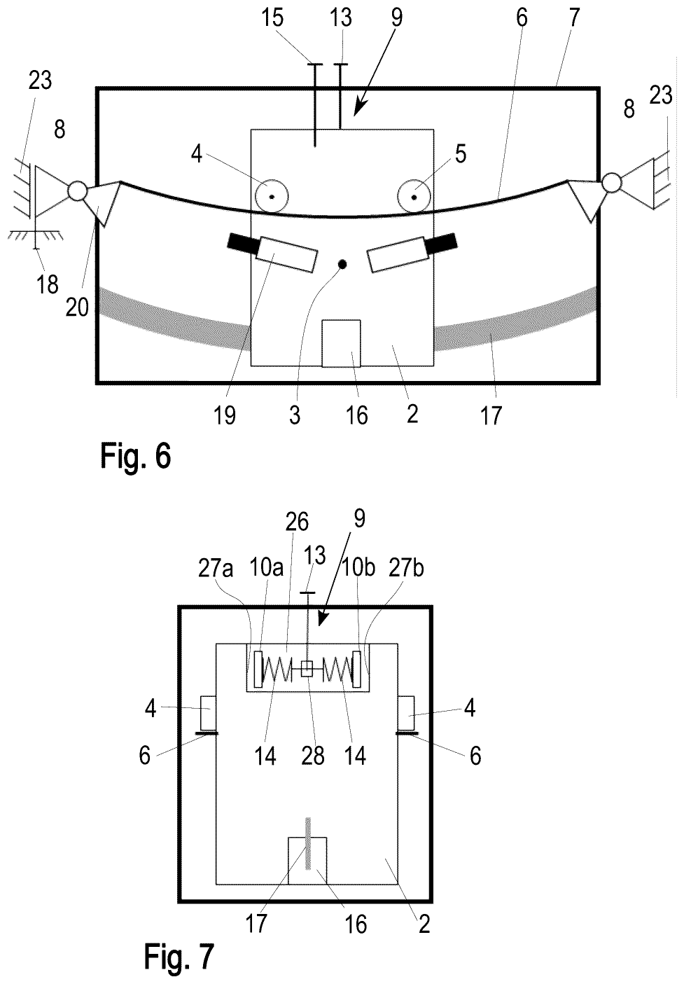

FIGS. 6 and 7 show a modified embodiment of a vibration absorber arrangement 1. In this case, the friction damper device 9 comprises two friction lining elements 10a, 10b arranged in a groove 26 formed in the absorber mass 2. The friction lining elements 10a, 10b are each pressed in the horizontal direction (with respect to the direction of gravity) against a friction surface 27a, 27b by the bias spring arrangement 14, which may, just as in the illustration of FIG. 5, comprise a first spring 24 and a second spring 25 with different stiffnesses, when the friction damper device 9 is to interact with the absorber mass 2 in a damping manner. If such damping is not desired, the friction lining elements 10a, 10b can be lifted off the friction surfaces 27a, 27b as shown.

The friction surfaces 27a, 27b run essentially parallel to the direction of gravity and parallel to the extension of the rail arrangement 6, so that when the friction lining elements 10a, 10b frictionally interact with the friction surfaces 27a, 27b, no force is exerted by the friction lining elements 10a, 10b in the direction of gravity on the absorber mass 2. Under unfavorable circumstances, such a force in the direction of the gravity could have an undesirable effect on the vibration behavior of the absorber mass 2, so that the absorber frequency is changed in an impermissible manner.

A coupling of the friction lining elements 10a, 10b to the enclosure 7 via a lever is not necessary here, since no change in position in the direction of gravity of the friction lining elements 10a, 10b occurs when the friction lining elements 10a, 10b are brought abut with the friction surfaces 27a, 27b.

The adjustment device 13 further acts on the friction damper device 9 from above, namely via a schematically shown direction-change gear 28 (angular gear 28), which may be designed, for example, as a worm gear.

The locking device 15 can also be used here to secure the absorber mass 2 brought to a standstill against further movement.

What is claimed is:

1. Vibration absorber arrangement, in particular for tall slender structures, having a supporting structure, an absorber mass, which comprises a center of mass, and at least one wheel, by means of which the absorber mass is movable on a rail arrangement, which is concavely cured and connected to the supporting structure, from a stable central position in two opposite directions, wherein a friction damper device is provided,
characterized in that the friction damper device is adjustable between a first state, in which it does not interact with the absorber mass or only dampeningly, and a second state, in which it controlledly brings a movement of the absorber mass to a standstill.

2. Vibration absorber arrangement according to claim 1, characterized in that the friction damper device comprises a bias spring arrangement, which is arranged between an adjustment device and at least one friction lining element.

3. Vibration absorber arrangement according to claim 2, characterized in that the friction lining element comprises a usable thickness and the bias spring arrangement has a spring constant, wherein a spring force of the bias spring arrangement between a first spring length and a second spring length, which is a sum of the first spring length and the usable thickness, changes by less than 10%.

4. Vibration absorber arrangement according to claim 3, characterized in that the adjustment device overpresses the bias spring arrangement in the second position.

5. Vibration absorber arrangement according to claim 3, characterized in that the bias spring arrangement comprises a first spring and a second spring, which are arranged in series and have different stiffnesses.

6. Vibration absorber arrangement according to claim 2, characterized in that the at least one friction lining element interacts with a friction surface, which is aligned in the direction of gravity.

7. Vibration absorber arrangement according to claim 6, characterized in that the absorber mass comprises a groove and the friction surface forms a side wall of the groove.

8. Vibration absorber arrangement according to claim 6 characterized in that the adjustment device has an angular gear, in particular a worm gear.

9. Vibration absorber arrangement according to claim 1, characterized in that a locking device is provided, by means of which the absorber mass is securable relative to the supporting structure, in particular in several different positions.

10. Vibration absorber arrangement according to claim 1, characterized in that an inclination adjustment device is provided, by means of which an inclination of the vibration absorber arrangement is changeable, wherein the vibration absorber arrangement comprises in particular an enclosure, which is connected to the supporting structure, wherein the inclination adjustment device acts in particular on the enclosure.

11. Vibration absorber arrangement according to claim 1, characterized in that between the absorber mass and an end stop an impact buffer arrangement is provided, which comprises a force transmission device connected to the supporting structure, wherein the impact buffer arrangement comprises in particular an impact damper and the center of mass, the impact damper and the force transmission device lie in line, when the absorber mass reaches force transmission device, whereby the impact buffer arrangement preferably defines a braking distance corresponding to at least 10% of maximum deflection of the absorber mass.

12. Vibration absorber arrangement according to claim 1, characterized in that the absorber mass is connected to the supporting structure via an auxiliary spring device.

13. Vibration absorber arrangement according to clain 1, characterized in that it comprises an eddy current damper having a magnet arrangement and an electrical conductor arrangement, whereby the magnet arrangement and the conductor arrangement upon movement of the absorber mass relative to the supporting structure move relative to each other.

14. Vibration absorber arrangement according to claim 1, characterized in that the rail arrangement is a first rail arrangement, the absorber mass is a first absorber mass, and a second absorber mass is movable on a second rail arrangement, which is concavely curved and connected to the supporting structure and aligned transversely to the first rail arrangement, from a stable central position in two opposite second directions, wherein the first absorber mass and the first rail arrangement are arranged in a first enclosure, the second absorber mass and the second rail arrangement are arranged in a second enclosure, and the first enclosure and the second enclosure are arranged one above the other in the direction of gravity.

15. Vibration absorber arrangement according to claim 14, characterized in that the second enclosure is arranged off-center with respect to the first enclosure in the direction of the first rail arrangement and/or the first enclosure is arranged off-center with respect to the second enclosure in the direction of the second rail arrangement.
